(19) United States
(12) Patent Application Publication
(10) Pub. No.: US 2008/0135341 A1
(43) Pub. Date: Jun. 12, 2008

(54) Lifting Apparatus

(76) Inventor: Craig Pollard, Tokoroa (NZ)

Correspondence Address: YOUNG & THOMPSON, 209 Madison Street, Suite 500, ALEXANDRIA, VA, 22314, US

(21) Appl. No.: 11/721,711

(22) PCT Filed: Dec. 14, 2005
(86) PCT No.: PCT/NZ05/00330

§ 371 Date: Aug. 29, 2007

(30) Foreign Application Priority Data
Dec. 14, 2004 (NZ) 537191

(51) Int. Cl. B66F 9/12; B66F 9/075

(52) U.S. Cl. 187/237; 29/897.2

(57) ABSTRACT

The present invention is directed to the apparatus and manufacture of lifting apparatus (1) in the form of improved forklift tines. The lifting apparatus includes at least one lifting tine (3) having an upper surface (4), a lower surface (5), a heel and a tip (9). The upper surface is substantially planar and the lower surface is substantially tapered from the heel of the lifting tine to the tip of the lifting tine. The taper of the lower surface includes at least three reductions (6, 7, 8) in the angle of the taper along the length of the tine. The upper surface includes indentations having potentially coded, to assist the operator of the lifting apparatus with placement and operation of the lifting apparatus. The lifting apparatus is adapted for use with cushioning apparatus (13) to cushion the impact of the forklift tines against objects being lifted by the tines, such as pallets and the like to assist in reducing damage to pallets and products and improve safety in the operation of forklifts.

### TECHNICAL FIELD

The present invention is directed to improvements in and relating to lifting apparatus.

In particular, the invention relates to the apparatus and manufacture of, improved forklift tines. In addition, the forklift tines will be used in conjunction with apparatus for cushioning the impact of the forklift tines against objects being lifted by the tines, such as pallets and the like.

It is envisaged the forklift tines will assist in reducing damage to pallets and products and improve safety in the operation of forklifts. In addition, when the forklift tines are used in conjunction with the cushioning apparatus it is envisaged the reduction in damage to pallets and products will be further enhanced.

However, it should be appreciated this invention may have applications outside this field.

### BACKGROUND ART

Forklifts and pallet jacks are very common apparata used in a wide range of industries to move around products packed or contained on pallets, in drums or the like.

A forklift is a small industrial vehicle with a power operated forked platform in front that can be inserted under loads to lift and move them. The forked platform can be slid under heavy loads and then raised for moving and stacking materials in warehouses, shipping depots, etc. The forks are made from steel.

A pallet jack is a manual version of the forklift. The handle of the pallet jack operates as a pump mechanism and relies on the use of pneumatics or hydraulics to raise and lower the tines. The tines are lowered for insertion or withdrawal from between the stringers of a pallet and then raised to move the pallet around.

Both the forklift and the pallet jack have become indispensable pieces of equipment in many manufacturing, transportation and warehousing operations. For example, approximately 90% of the U.S. domestic product is shipped on pallets. Such pallets need to be moved, stacked and un-stacked several times during the manufacturing, transportation and warehousing operations.

Three components are critical in determining load material handling efficiency (and costs). These are packaging, pallets, and material handling equipment. Pallets and packaging work as a system to determine overall unit load performance. For most products, the pallet and packaging used to unitise, protect and transport the product represent a significant percentage of costs.

Therefore, most companies spend considerable resources in packaging development, or to improved pallet design, as there are many ways to modify packaging and pallet design that will save on overall unit load costs. In earlier times, heavy-duty deckboards and stringers and high quality nails were used to produce pallets. Today's pallets are a highly variable mix of trimmed-down designs that are frequently damaged after 1 or 2 trips. For the vast majority of unit loads, it is clear that the lowest-priced pallet is usually not the lowest cost pallet, as reducing pallet price often drives up other factors, such as product damage, additional protective packaging, and labor for increased handling.

It is here that the impact of the material handling equipment becomes important. In particular, the impact of the forklift should not be underestimated. Forklift accidents and damage to pallets and product are some of the less desirable factors of forklift use. Pallets with damaged stringers resulting from the impact of forklift tines are less effective in protecting loaded products from damage and pallets frequently require replacement at a cost to the organisation. Whilst there are a number of behavioural, mechanical, operational, work place design and load characteristics which contribute to these factors, the design of the forklift tines contributes to many problems encountered. Yet little emphasis has been placed on revising forklift tine design.

Changes have been made to pallets to make them more durable or less likely to be impacted on by the forklift tines. For example some pallets are even manufactured from plastic materials. One such design includes deflection means on the platform ribs such that on entry of the forklift tines, the tines are more appropriately directed into the channels.

While the present invention has a number of potentially realisable applications, it is in relation to providing improvements to the material handling equipment component of product handling that the present invention was developed. More specifically, it was with the problems associated with existing forklift tine design, and to improved safety in the workplace by providing an alternative to existing forklift tine design for enhanced benefits to the user, that the invention was developed.

In addition, it is with the desire to minimise the blunt impact of the forklift tines and associated structures against the structure of the pallet that the additional features of the invention was developed.

It is with these objectives in mind that it would be useful therefore, to have forklift lifting system that:
a) Enabled the forklift tines to be more easily inserted in between the stringers without damaging the deckboards or the stringers themselves; and/or
b) Included means which enabled the forklift driver to more clearly see the position and orientation of the forklift tines with respect to the pallet and/or load; and/or
c) Was relatively easy and cost effective to produce; and/or
d) Could include means to additionally cushion the impact of the forklift times against the pallet structure; and/or
e) Was also designed to improve workplace safety by heightening the visibility of the forklift tines both when at rest and during operation of the forklift.

It would be advantageous to have an invention that offered at least some if not all of the advantages of the above proposed forklift lifting apparatus. Therefore, it is an object of the present invention to consider the above problems and provide at least one solution which addresses a plurality of these problems.

It is also a further object of the present invention to at least provide the public with a useful choice or alternative system.

Further aspects and advantages of the present invention will become apparent from the ensuing description which is given by way of example only. It should be appreciated that variations to the described embodiments are possible and would fall within the scope of the present invention.

### DISCLOSURE OF INVENTION

For the purpose of this specification, the term forklift means and includes any apparatus with an operable forked platform in front that can be inserted under loads to lift and move them. Whilst the present description relates more to a powered forklift vehicle, the present invention also has application with respect to pallet jacks and similarly operable hydraulic/pneumatic lifting apparata.

In addition, whilst the present application is described with reference to forklift tines, it should be appreciated that various aspects of the concept may be applied to other forms of lifting apparata.

A typical forklift includes a truck, which is a motive machine with wheels powered through a transmission and drive train, relying on an internal-combustion (LPG, gasoline or diesel) engine, or a battery-powered motor. The forklift also includes a counterweight, which is a heavy iron mass attached to the rear of the machine, necessary to compensate for the load. In an electric forklift, the large lead-acid battery itself may serve as a counterweight. Forklifts operate on the simple principle of a fulcrum or like a playground see-saw. Weight on the forks must be counterbalanced by the counterweight and weight of the forklift. The fulcrum, or pivot, is the drive axle. Forklifts are rated for loads at a specified maximum weight and a specified forward center of gravity. This information is typically located on a nameplate provided by the manufacturer, and loads must not exceed these specifications.

The operator sits in an associated cab. The cab is typically open and bounded by a cage-like overhead guard assembly, comprising a metal roof supported by posts, that helps protect the operator from any falling debris. The cab includes a seat for the operator to sit on and pedals and switches for controlling the machine. There is also a load back rest which is a rack-like extension attached to the carriage to prevent the load from shifting backward

Forklift trucks are typically designed to lift around one ton, though larger and smaller machines exist. A forklift must be physically small and compact to work in confined areas, such as boxcars, container vans, and narrow aisles. Additionally, the forklift must offer enough working space for both the operator and maintenance personnel. It must handle maximum loads and stack them safely and still have an upright, minimum load, and collapsed height to maneuver in areas with low-overhead clearance. It must be able to negotiate inclines, either empty or loaded.

The mast of the forklift is the vertical assembly that does the work of raising, lowering, and tilting the load via the forklift tines. The mast is hydraulically operated and consists of a cylinder and interlocking rails for lifting and lowering operations and for lateral stability. The carriage of the forklift comprises flat metal plate(s) moved along the mast by means of chains

In addition to a control to raise and lower the forks (also known as blades or tines), the operator can tilt the mast to compensate for a load's tendency to angle the blades toward the ground and risk slipping off the forks. Tilt also provides a limited ability to operate on non-level ground. On some machines the sideshift feature allows the tines and backrest to move laterally allowing easier precision placement of a load. Grab attachments for handling barrels or even kegs also have a control to operate the tongs that grab the load.

The forks or tines are L-shaped members that engage the load. The back vertical portion of the fork attaches to the carriage by means of a hook or latching means; the front horizontal portion is inserted into or under the load.

There are a number forklift tine designs available, depending on the use to which they are applied. A standard taper or pallet fork is the most popular of all tapers used for picking up skids or pallets. Normally, the taper begins 16″ to 24″ from tip and end with a ⅜″ tip. On the other hand, a full tapered tine has a taper which begins at the heel of the fork and extends to the tip, ending with ⅜″ tip. This design is good for getting under plywood or cardboard boxes. A full taper polish and chisel point tine is the same as the full taper tine, but has ⅛″ tip and is mainly used in plywood applications.

In addition, there are a number of attachments designed for use with forklifts and forklift tines. For example, forklift extensions/extenders provide additional length to the forklift tines that permits an easier way to load tractor-trailers and variously configured pellets. However, the extender moves the center of gravity of the load and this restricts the weight that can be lifted. Forklift extensions or tine (fork) extenders are designed in two configurations. These are the bare tine extender and rollerised tine extenders.

The crane boom attachment converts the forklift to a mobile crane jib capable of handling bulky, irregularly shaped objects and is a valuable aid in maintenance work. The crane boom is raised or lowered with the standard lift mechanism.

A drum-handling attachment can handle filled 55-gallon drums by means of a forklift truck. One type of drum-handling attachment consists of a series of specially shaped and spaced forks that cradle the drums to be handled. Some such attachments are capable of handling more than one filled drum at one time. The second type is mounted on the forks of the forklift and consists of side rails from which specially designed hooks are suspended at the front and rear. The attachment is lowered over the drums until the hooks drop into position over the drum rims. This attachment can handle two filled drums at one time. The third type is vertically operated and handles one filled drum at one time.

There are also a range of pallet types, including stringer, skid and block-type pallets. Stringer pallets have upper and lower deckboards and are designed to allow only forklift entry on the sides if stringers are notched (partial 4-way entry). If stringers are not notched, pallet jacks and forklifts can only enter on the 2 ends and they are called “2-way”. Block pallets provide fall access on all 4 sides for both forklifts and pallet jacks (full 4-way). A skid pallet is a stringer pallet with no bottom deckboards.

Most pallets are manufactured flush, with deckboard ends flush with the outer stringer sides. Others may include a pallet wing which is the length of deckboard overhanging past the outer pallet stringers. Pallet stringers act as deckboard supports. The bending strength and stiffness of deckboards is determined in part by the free span between stringers. If a 48×40-inch pallet has 1½ wide stringers, the deckboard span between stringers is 17¾ inches ((40−3(1.5))/2). If the outer stringers are inset 2 inches (2″ wing), the pallet still measures 48×40 inches, but the deckboard span is now only 15¾ inches. Deckboards are typically spaced evenly across the top and bottom pallet decks and are needed to support key parts of the packaging and to prevent product damage from forklifts. Most forklift tines are 40-46 inches in length. Deckboards at likely tine tip locations reduce tine tip damages.

Adding deckboards is not usually as cost effective as increasing deckboard thickness, but is the best solution for some product applications. More deckboard coverage will better protect products from forklifts, increase strength, stiffness, and durability, and will better support a variety of product sizes. Adding additional deckboards will increase pallet price, and should be compared with potential savings in protective packaging and opportunities for product redesign.

Notches allow forklift tine entry on the pallet sides. In many cases, notches are specified by default. Notches add to the pallet price while reducing strength and durability.

Pallets are also manufactured from a range of materials, including solid wood, plywood, corrugated, molded paper, plastics, and metal. Although alternative pallet materials (non-wood) have gained significant market share in the last decade, wood pallets still comprise about 90% of the pallet market. Wood pallets are usually manufactured from the most economically-attractive lumber species that provides adequate performance and that is readily available in a given marketplace. Most wood lumber pallets are however manufactured having a “green” moisture content, or 40-60% moisture content. Other pallets may be made using softwoods available as kiln dried pallet lumber. While good pallets can be manufactured from almost any species, pallet specifications need to be adjusted to emphasize strengths and minimize weaknesses of each species, according to density and shock resistance.

Unfortunately, use of forklifts in moving and stacking pallets frequently results in damage to the pallet deckboards, stringers and products loaded on to the pallets. Pallets with damaged stringers are less likely to protect products and damaged pallets are unsuitable for use and require replacement at a cost to the organisation.

The forks cause such damage to the pallets, product and packaging due to their square edges and typically long angular design. This is particularly the case with the full tapered forklift tine design. In addition, when the forklift tines are being positioned for entry between the stringers of the pallet, the forks almost touch the ground and often hit the bottom front of the pallets when engaging them.

Further, the forks are hard to see. They are made of black steel and it is generally difficult for the operator of the forklift to easily gauge where the tips of the forklift tines are when approaching a pallet—which may be in darkened areas, or where there is little room to easily manouevre. The difficulty of easily seeing the forklift tines also becomes a safety issue in the work place.

It is with such problems and practical considerations in mind that the present invention was devised.

According to one aspect of the present invention, there is provided lifting apparatus, said lifting apparatus including at least one lifting tine said lifting tine including an upper surface and lower surface, the upper surface being substantially planar, the lower surface being substantially tapered from the heel of the lifting tine to the tip of the lifting tine, and the lifting apparatus characterised in that the taper of the lower surface includes at least three reductions in the angle of the taper along the length of the tine.

According to another aspect of the present invention, there is provided lifting apparatus substantially as described above wherein the lifting apparatus includes a back rest, said backrest being adapted to engage with the structure of a machine with which the lifting apparatus is used.

According to another aspect of the present invention, there is provided lifting apparatus substantially as described above wherein the at least three reductions in the angle of the taper along the length of the tine are equally spaced along the length of the tine.

According to another aspect of the present invention, there is provided lifting apparatus substantially as described above wherein the at least three reductions in the angle of the taper along the length of the tine are located towards the tip of the tine.

According to another aspect of the present invention, there is provided lifting apparatus substantially as described above wherein the angle of the taper closest to the tip of the tine is such that when the tine is positioned at its lowest level, the tip of the tine is raised up above the surface on which the tine is resting.

In preferred embodiments of the present invention, the angular reductions in the taper along the length of the lifting tine result in a smaller angle of the tine at the tip, such that, even when the tine it is sitting at its lowest level, the tip of the tine is still higher than the bottom front board of the pallet. Thus the reduction in tapering provides strength to the heel of the forklift tine, yet ensures the tip is positioned for easy insertion between the stringers of the pallet, without the tip crashing into the lower deckboards or other lower structural features of the pallet. The reduction in strikes of the tines against the pallet structure reduces the likely damage to the pallet in these areas.

In addition, it is preferable that the reductions in angle of the taper are substantially located at each third of the length of the tine. However, in other embodiments the angular reductions of the taper may be varyingly located along the tine length.

Whilst in preferred embodiments there are three angular reductions along the length of the tine, the number and point of reduction may vary depending on the configuration of the tine and the use for which it is designed.

According to another aspect of the present invention, there is provided lifting apparatus substantially as described above wherein the lower surface of the lifting tine is substantially rounded.

According to another aspect of the present invention, there is provided lifting apparatus substantially as described above wherein the tip of the lifting tine is substantially rounded.

Preferably, the tine also has a rounded tip. A rounded tip is preferable to a flat or square ended tip as when the forklift is driven towards a pallet and is steered in at a sharp angle the rounded tip of the tine rolls around and over the pallet structural stringers smoothly.

Preferably the tine has rounded shapes to the bottom, tip and edges of the tine to minimise the likelihood of tearing or shattering of the edges of the timber of the pallets when the tines contact the pallet. Rather the rounded edges enable the tine to roll around or over the wooden or plastic structures of the pallet and, in the case of wooden pallets can minimise the likelihood of splinters from broken pallet timber being directed into and onto the product.

According to another aspect of the present invention, there is provided lifting apparatus substantially as described above wherein the upper surface of the lifting tine includes indentations.

As previously described, the lifting tines of forklifts are hard to see in various situations because of the dark colour of the steel from which they are manufactured. As a result of the use the tines are exposed to, any attempts to improve visibility of the tines by painting them would be short-lived as the paint would rub of very quickly. Accordingly, the tines of traditional design are very hard to make visible.

Some work areas and stores are dark and as such it is difficult for the operator to see where the tines are being put. Preferably therefore, it is an aspect of the present invention that various indentations are milled out of one or more of the upper surface, lower surface, sides or tips of the tines, as well as the backrest portion of the tine. The indentations may be linear, zig-zag, spot holes, or any other configuration required. In addition, the indentations may be represented in a pattern, located at specific points on or along the surfaces and be of any depth. Further, it is preferable that the indentations include high visibility colouring.

It is preferable that the tines include indentations as opposed to protrusions as the protrusions would catch on the pallet or other loads being lifted and raise the potential for damage to the pallet or load. In addition, having indentations means that any colours used therein is less likely to rub off because the pallet structures do not touch them.

The indentations on the upper surface may be represented as linear strips to provide the operator of the forklift with a visual appreciation of the length of the tines. Such strips may be continued on the underneath of the tines and on the backrest. The strips are preferably continuous to provide the operator with a visual line to judge placement of the tine into the pallet.

In addition, there may be colour coding applied to the strips. For example, strips located toward the outside edges of the tine may be of different colours, for example green and orange, to provide a visual appreciation of the inside and outside edges of the tine.

It is preferable that the colours have high visibility from the forklift seat and accordingly, some colours would be preferable to others having regard to instances of colour blindness in individuals.

In additions, the indentations may include circular indentations or the like. These may be arranged in patterns and be colour coded as with any strip or zig-zag indentations. However, in application, such indentations may provide a horizontal as opposed to a linear gauge and be used to enable an operator to judge how far on to the tines the pallet is located. This may be relevant to pallets of different width, where it is important to pass the tines through the pallet a required distance to provide appropriate support to the pallet when lifting it, yet not extend so far through as to cause damage to surrounding structures or pallets by the tips of the tines.

In preferred embodiments of the present invention there is included a centre line indentation. Preferably this centre line will have reflective paint or tape for high visibility. High visibility of the tine is important not only to the operator, but also to any other individuals in the area in which the forklift may be operating. This is particularly relevant in noisy environments where the sound of an approaching forklift may be masked by surrounding noise. Having highly visible forklift tines contributes to improved safety in the workplace.

According to another aspect of the present invention, there is provided a method of manufacturing lifting apparatus, said lifting apparatus including at least one lifting tine, said lifting tine including an upper surface and lower surface, the upper surface being substantially planar, the lower surface being substantially tapered from the heel of the lifting tine to the tip of the lifting tine, and the lifting apparatus characterised in that the taper of the lower surface includes at least three reductions in the angle of the taper along the length of the tine.

According to another aspect of the present invention, there is provided cushioning apparatus for use with lifting apparatus substantially as described herein, said cushioning apparatus including at least one telescopic arm.

The cushioning apparatus for use with the present invention preferably includes at least one telescopic arm. The telescopic arm includes at least two portions. An outer portion is attachable to a portion of the forklift on the back plate and in the vicinity of the forklift tines. At least one inner telescoping portion is smaller than and extends from the outer portion. The cushioning apparatus may be operated via connection to the hydraulic system of the forklift, or may be spring operated or similar. At least two, but preferably three telescopic arms are employed.

With reference to the spring operated system, application of pressure to the inner telescoping portion causes displacement of a resilience means, which in turn effects a sliding movement of two side arms of the cushioning apparatus to cause the load applied to the inner portion from contact with a springer, to be also displaced.

The cushioning apparatus is designed to be applied to the bearers or springers of the pallet in advance of the forklift tines. With a spring operated version, the middle bearer or springer of the pallet would first take the load applied by the forklift pressure directing a mid-positioned telescopic arm against the springer. The inner telescopic portion of the middle arm would then be pushed telescopically into the outer portion. As the two side telescopic arms are then applied to the side springers of the pallet, the load is transferred from the middle springer to the outside springers. Caution is required when then directing the tines through the pallet.

The hydraulic system would work in a similar manner, but be operated by connection to the hydraulics of the forklift.

An electronic photo-eye may also be employed to appropriately position, detect and initiate operation of the cushioning apparatus, with reference to the relative location of the pallet and its load. The photo-eyes are set to engage the hydraulic pump when the tines of the forklift are half way into the pallet. The photo-eye may also be linked to a buzzer or similar audible signal producer, to alert the operator to the position achieved.

Preferably, the photo-eye is switch operated, so that in instances where it is necessary to narrow the distance between the forks, the photo-eye can be turned off so that the cushioning apparatus is not activated and so that the protruding cushioning apparatus does not push the fork tines out.

The cushioning apparatus is designed to minimise damage to the front deckboard of a pallet by it being pushed back until it hits the next deckboard, typically spaced 10-25 mm behind it. Rather the cushioning apparatus protects the load on the pallet by the cushioning apparatus bearing against the springers of the pallet where the pressure is then applied rather than on the front deckboard.

Either of the above systems may be adapted for use with multi-springered pallets.

As can be appreciated the damage caused by forklifts on pallet structure and product loads may be reduced by use of the present invention. It is estimated approximately 25% reduction in damage to pallets may be achievable using the improved lifting apparatus and this reduction may be increased up to 80% when the lifting apparatus is used in conjunction with the cushioning apparatus.

As can be appreciated variations to and from the above described embodiments may be made without deviating from the scope of the present invention.

It should further be appreciated a variety of different embodiments, uses, and applications of the present invention exist.

Specific embodiments for the present invention will now be given by way of example only, to help better describe and define the present invention. However, describing one embodiment should not be seen as limiting the scope of this invention.

### BRIEF DESCRIPTION OF DRAWINGS

Further aspects of the present invention will become apparent from the following description, given by way of example only and with reference to the accompanying figures, tables and illustrations in which:

FIG. 1a,b Are diagrammatic side representations of a standard forklift tine and a tine of the present invention, for the purpose of describing the application of the present invention; and

FIG. 2a, b Are diagrammatic side representations of a standard forklift tine and a tine of the present invention with reference to a pallet, for the purpose of describing the application of the present invention; and

FIG. 3a, b Are diagrammatic top plan representations of a standard forklift tine and a tine of the present invention with reference to a pallet, for the purpose of describing the application of the present invention; and

FIG. 4a, b Are diagrammatic bottom plan representations of a standard forklift tine and a tine of the present invention with reference to a pallet, for the purpose of describing the application of the present invention; and

FIG. 5a, b Are diagrammatic end representations of a standard forklift tine and a tine of the present invention with reference to a pallet, for the purpose of describing the application of the present invention; and

FIG. 6a, b Are diagrammatic front representations of a the back rest of a standard forklift tine and a tine of the present invention with reference to a pallet, for the purpose of describing the application of the present invention; and

FIG. 6c, d Are diagrammatic front and bottom perspective views respectively, of a lifting tine of the present invention; and

FIG. 7 Is a diagrammatic perspective representation of a hydraulic cushioning apparatus of the present invention; and

FIG. 8 Is a diagrammatic representation of spring operated cushioning apparatus of the present invention; and

FIG. 9a-c Are diagrammatic representations of the operation of the cushioning apparatus of the present invention.

### BEST MODES FOR CARRYING OUT THE INVENTION

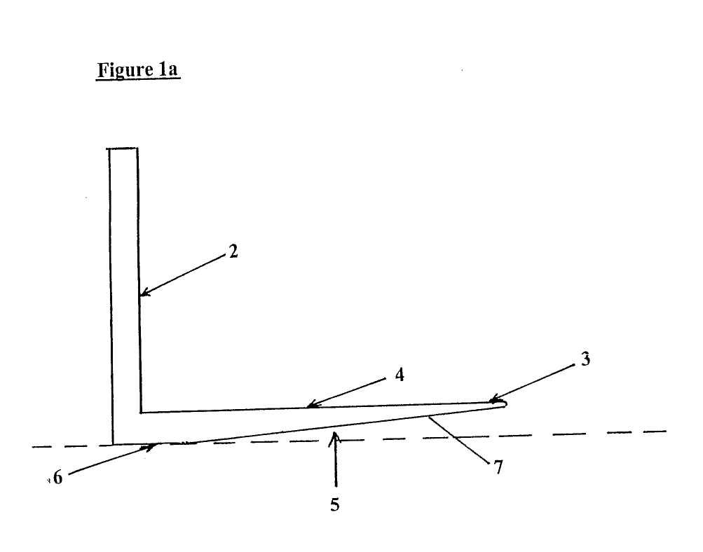

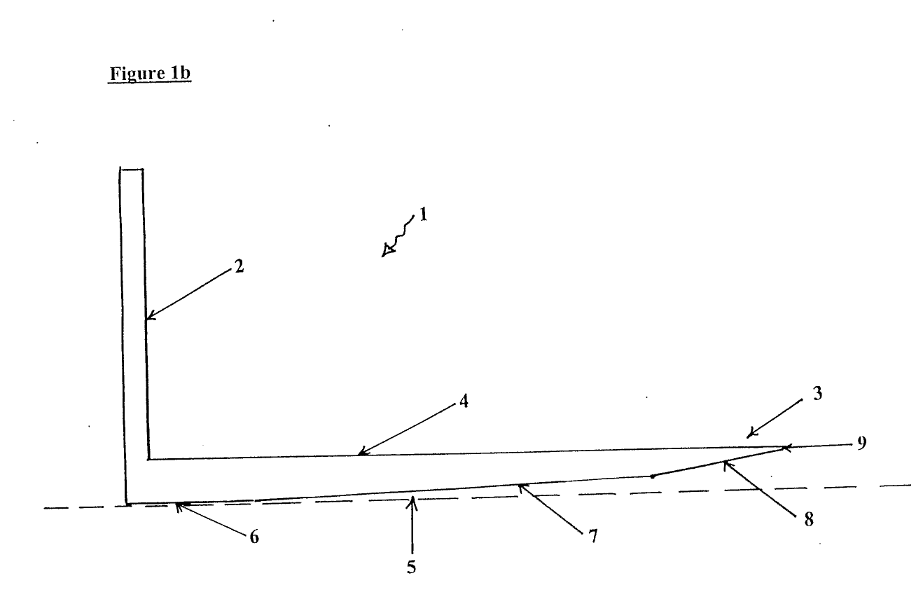

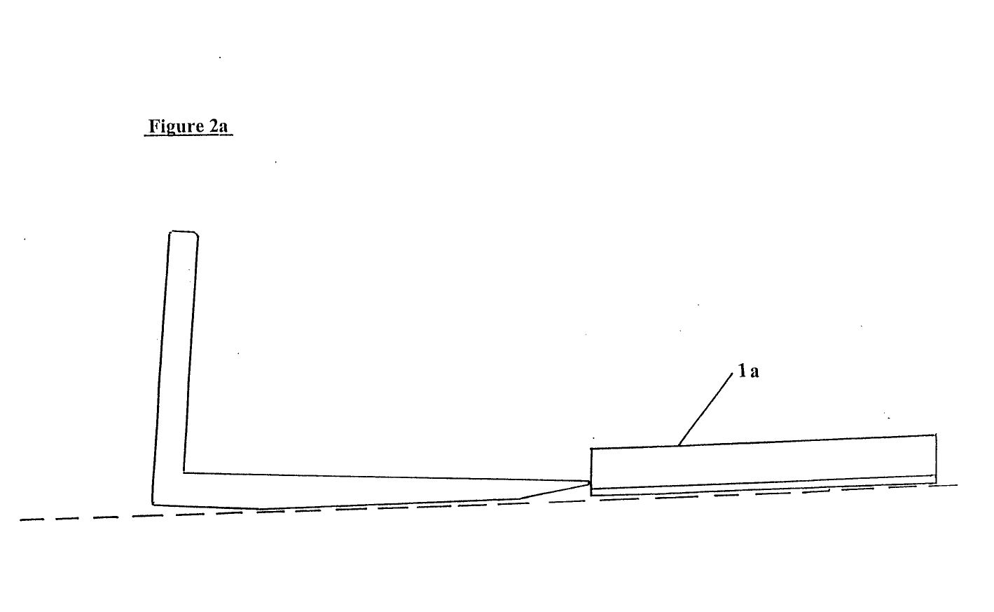

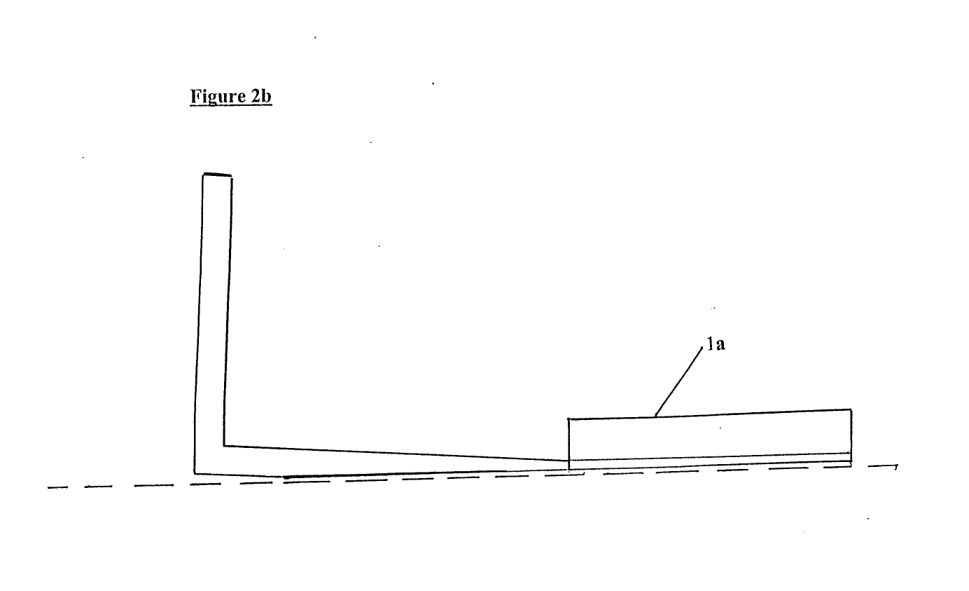

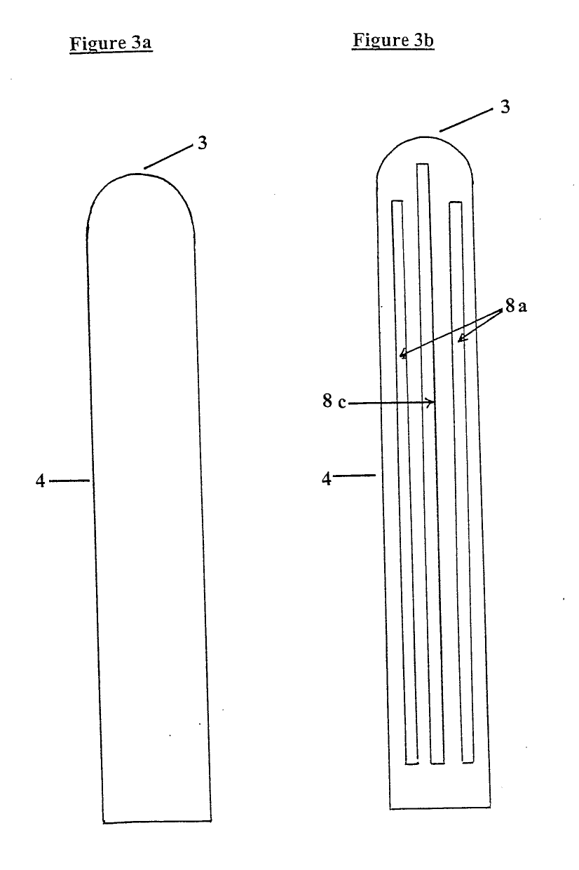

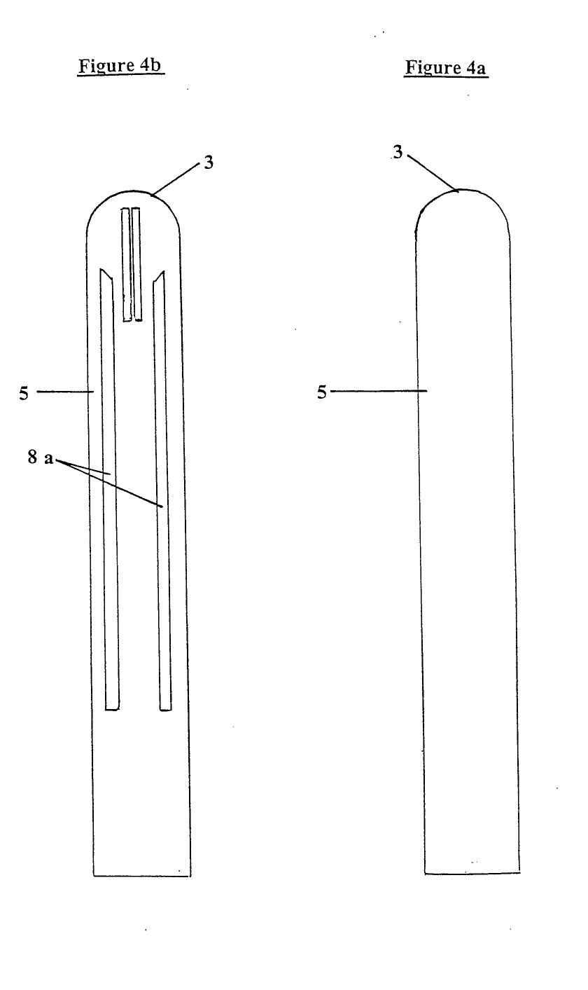

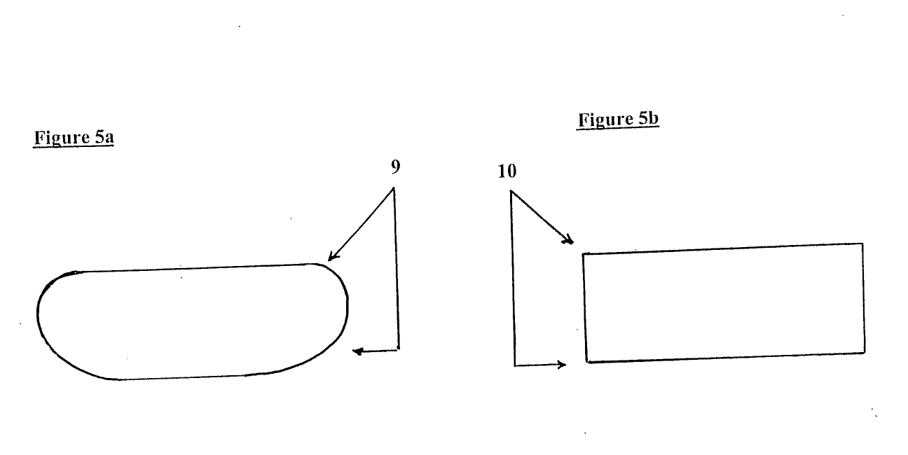

With reference to the FIGS. 1-6d and examples, there is provided a lifting apparatus generally indicated by arrow 1, said lifting apparatus including a back rest 2 and at least one lifting tine 3, said lifting tine including an upper surface 4 and lower surface 5. The upper surface 4 being substantially planar, the lower surface 5 being substantially tapered from the heel of the lifting tine to the tip 9 of the lifting tine. The lifting apparatus characterised in that the taper of the lower surface 5 includes at least three reductions in the angle of the taper from 6 (flat), to 7 (slight angle) to 8 (big angle) along the length of the tine. The back rest is adapted to engage with the structure of a machine with which the lifting apparatus is used.

The lower surface 5, edges and the tip 9 of the lifting tine are substantially rounded. A rounded shape is preferable to a flat or square shape as when the forklift is driven towards a pallet and is steered in at a sharp angle the rounded tip and lower surface of the tine rolls around and over the pallet 1a structural stringers smoothly and minimise the likelihood of tearing or shattering of the edges of the timber of the pallets when the tines contact the pallet and as such also minimise the likelihood of splinters from broken pallet timber being directed into and onto the product.

The upper surface 4 of the lifting tine includes indentations 8. As previously described, the lifting tines of forklifts are hard to see in various situations because of the dark colour of the steel from which they are manufactured. Accordingly, the indentations 8 are milled out of one or more of the upper surface, lower surface, sides or tips of the tines, as well as the backrest portion of the tine. The indentations may be linear, zig-zag, spot holes, or any other configuration required. In addition, the indentations may be represented in a pattern, located at specific points on or along the surfaces and be of any depth. Further, it is preferable that the indentations include high visibility colouring.

The indentations on the upper surface may be represented as linear strips as illustrated in the figures to provide the operator of the forklift with a visual appreciation of the length of the tines. Such strips may be continued on the underneath of the tines and on the backrest. The strips are preferably continuous to provide the operator with a visual line to judge placement of the tine into the pallet.

In addition, there may be colour coding applied to the strips. For example, strips 8a located toward the outside edges of the tine may be of different colours, for example green and orange, to provide a visual appreciation of the inside and outside edges of the tine.

It is preferable that the colours have high visibility from the forklift seat and accordingly, some colours would be preferable to others having regard to instances of colour blindness in individuals.

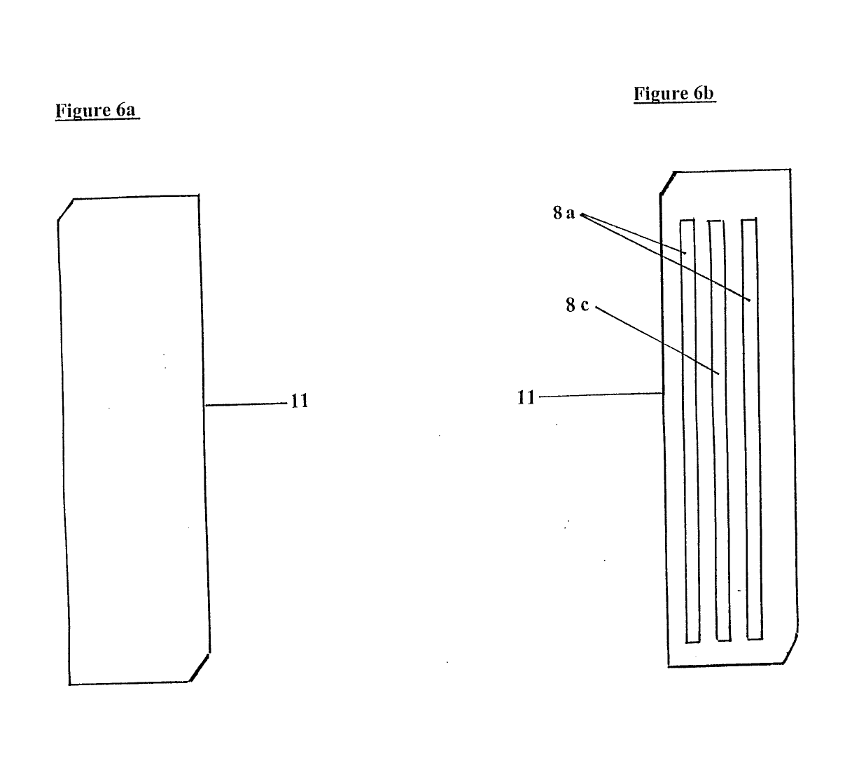

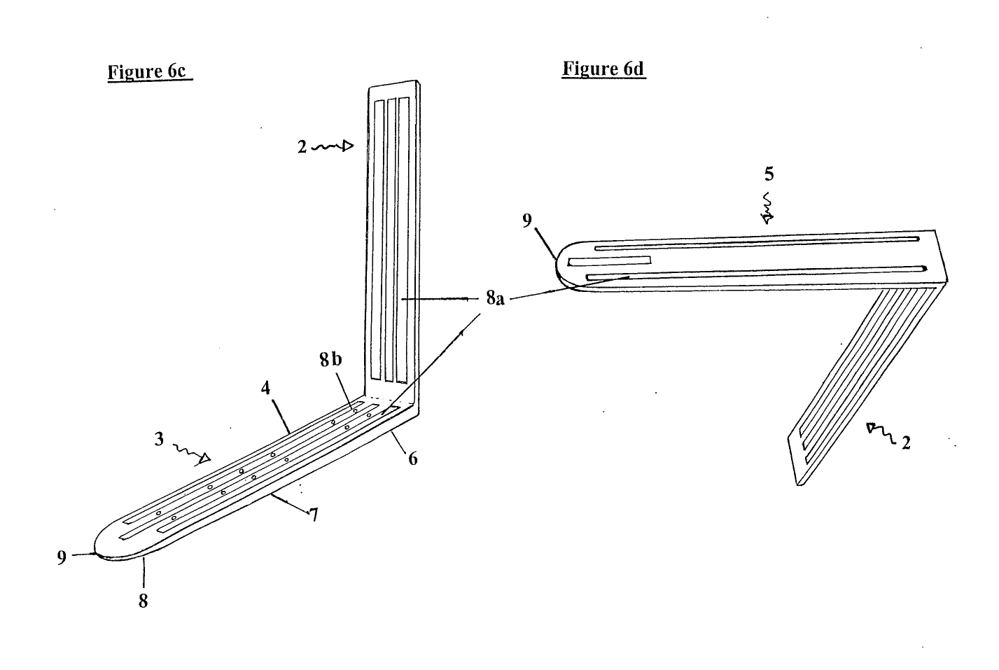

In addition, the indentations may include circular indentations or the like 8b as shown on FIG. 6d. These may be arranged in patterns and be colour coded as with any strip or zig-zag indentations and may provide a horizontal as opposed to a linear gauge and be used to enable an operator to judge how far on to the tines the pallet is located. This may be relevant to pallets of different width, where it is important to pass the tines through the pallet a required distance to provide appropriate support to the pallet when lifting it, yet not extend so far through as to cause damage to surrounding structures or pallets by the tips of the tines.

In preferred embodiments of the present invention there is included a centre line indentation 8c. Preferably this centre line will have reflective paint or tape for high visibility. High visibility of the tine is important not only to the operator, but also to any other individuals in the area in which the forklift may be operating. This is particularly relevant in noisy environments where the sound of an approaching forklift may be masked by surrounding noise. Having highly visible forklift tines contributes to improved safety in the workplace.

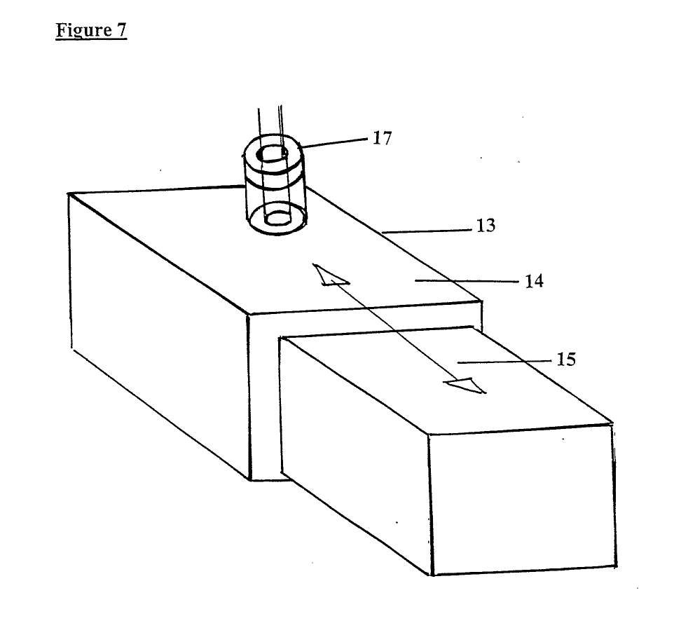

In addition, FIGS. 7 through 9 illustrate cushioning apparatus 13 for use with lifting apparatus 1. The cushioning apparatus including at least one telescopic arm 13. The telescopic arm includes at least two portions. An outer portion 14 is attachable to a portion of the forklift on the back plate and in the vicinity of the forklift tines. At least one inner telescoping portion 15 is smaller than and extends from the outer portion. The cushioning apparatus may be operated via connection to the hydraulic system of the forklift, or may be spring operated or similar. At least two, but preferably three telescopic arms are employed.

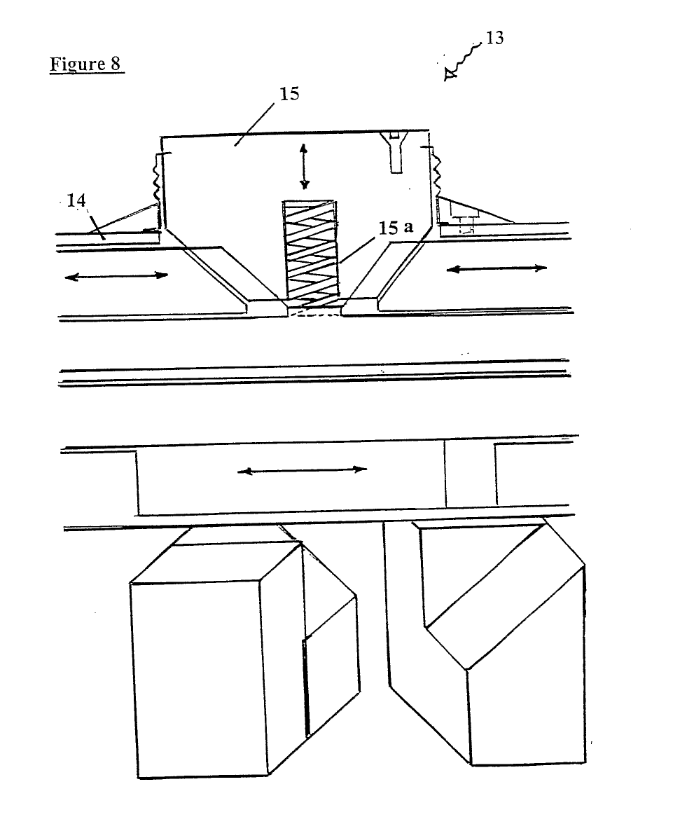

With reference to the spring operated system as shown in FIG. 8, application of pressure to the inner telescoping portion 15 causes displacement of a resilience means 15a, which in turn effects a sliding movement of two side arms 14 of the cushioning apparatus to cause the load applied to the inner portion from contact with a springer, to be also displaced.

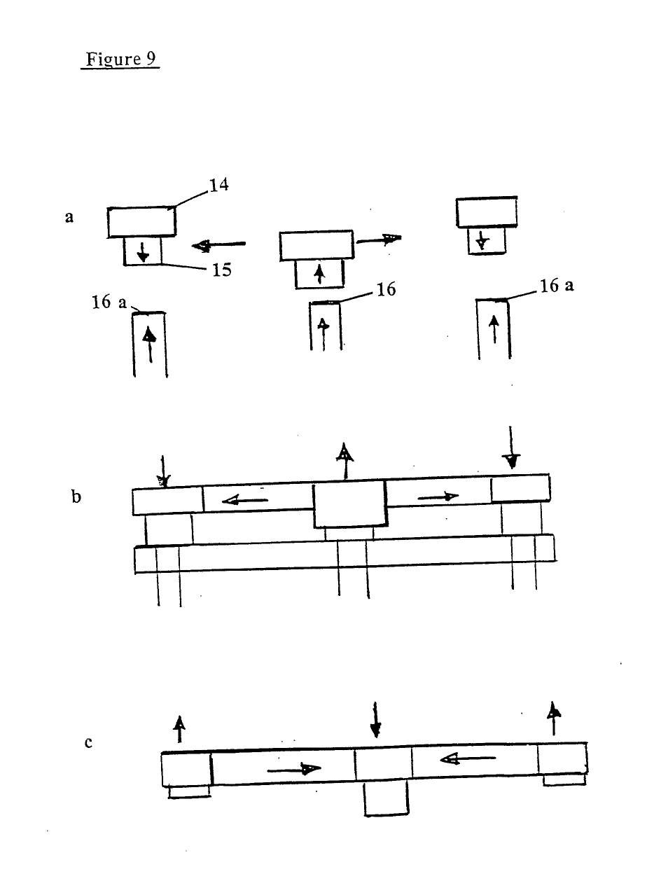

FIG. 9 a-c illustrate the operation of the cushioning apparatus, which is designed to be applied to the bearers or springers of the pallet in advance of the forklift tines. With a spring operated version, the middle bearer 16 or springer of the pallet would first take the load applied by the forklift pressure directing a mid-positioned telescopic arm against the springer. The inner telescopic portion of the middle arm would then be pushed telescopically into the outer portion. As the two side telescopic arms are then applied to the side springers 16a of the pallet, the load is transferred from the middle springer to the outside springers. Caution is required when then directing the tines through the pallet.

The hydraulic system would work in a similar manner, but be operated by connection to the hydraulics of the forklift.

An electronic photo-eye 17 may also be employed to appropriately position, detect and initiate operation of the cushioning apparatus, with reference to the relative location of the pallet and its load. The photo-eyes are set to engage the hydraulic pump when the tines of the forklift are half way into the pallet. The photo-eye may also be link to a buzzer or similar audible signal producer, to alert the operator to the position achieved.

Preferably, the photo-eye is switch operated, so that in instances where it is necessary to narrow the distance between the forks, the photo-eye can be turned off so that the cushioning apparatus is not activated and so that the protruding cushioning apparatus does not push the fork tines out.

The cushioning apparatus is designed to minimise damage to the front deckboard of a pallet by it being pushed back until it hits the next deckboard, typically spaced 10-25 mm behind it. Rather the cushioning apparatus protects the load on the pallet by the cushioning apparatus bearing against the springers of the pallet where the pressure is then applied rather than on the front deckboard.

It should also be understood that the term “comprise” where used herein is not to be considered to be used in a limiting sense. Accordingly, ‘comprise’ does not represent nor define an exclusive set of items, but includes the possibility of other components and items being added to the list. This specification is also based on the understanding of the inventor regarding the prior art. The prior art description should not be regarded as being an authoritative disclosure of the true state of the prior art but rather as referring to considerations in and brought to the mind and attention of the inventor when developing this invention.

Aspects of the present invention have been described by way of example only and it should be appreciated that modifications, additions and variations to and from the above described embodiments may be made without deviating from the scope of the present invention as described herein and defined in the appended claims.

1. Lifting apparatus, said lifting apparatus including at least one lifting tine said lifting tine including an upper surface and a lower surface, said lifting tine also including a heel and at tip, the upper surface being substantially planar, the lower surface being substantially tapered from the heel of the lifting tine to the tip of the lifting tine, and the lifting apparatus characterised in that the taper of the lower surface includes at least three reductions in the angle of the taper along the length of the tine.

2. Lifting apparatus as claimed in claim 1 wherein the lifting apparatus includes a back rest, said backrest being adapted to engage with the structure of a machine with which the lifting apparatus is used.

3. Lifting apparatus as claimed in claim 1 wherein the at least three reductions in the angle of the taper along the length of the lower surface of the tine are spaced along the length of the tine.

4. Lifting apparatus as a claimed in claim 3 wherein the at least three reductions in the angle of the taper along the length of the lower surface of the tine are equally spaced along the length of the tine.

5. Lifting apparatus as claimed in claim 3 wherein the at least three reductions in the angle of the taper along the length of the lower surface of the tine are located towards the tip of the tine.

6. Lifting apparatus as claimed in claim 4 wherein the angle of the taper along the length of the lower surface and closest to the tip of the tine is such that when the tine is lowered to rest at a level substantially parallel to a surface, the tip of the tine is raised up above the surface on which the tine is resting.

7. Lifting apparatus as claimed in claim 6 wherein the lower surface of the lifting tine is substantially rounded in cross-section.

8. Lifting apparatus as claim in claim 6 wherein the tip of the lifting tine is substantially rounded.

9. Lifting apparatus as claimed in claim 6 wherein any one or more of the upper surface of the lifting tine, the lower surface of the lifting tine, the sides of the lifting tine, the tip of the lifting tine, the backrest portion of the lifting tine includes indentations.

10. Lifting apparatus a as claimed in claim 9 wherein the indentations are adapted to take a preferred configuration, including linear, zig-zag, spot holes, or other preferred configuration of the indentations

11. Lifting apparatus as claimed in claim 10 wherein the indentations are adapted to be represented in any one or more of a preferred pattern, located at specific points on or along the surfaces, or be any depth.

12. Lifting apparatus as claimed in claim 11 wherein the indentations include either or both high visibility and reflective colours or materials.

13. Lifting apparatus as claimed in claim 12 wherein either or both the high visibility and reflective colours or materials used in conjunction with the configuration of the indentations and the placement of the indentations on the lifting tine are chosen to comply with a preferred code to enable the operator of the lifting apparatus or people in the vicinity of the lifting apparatus to make a visual appraisal of the length of insertion of the tines when lifting objects and/or to provide the operator with a visual line to judge placement of the tine beneath an object to be lifted.

14. Lifting apparatus as claimed in claim 12 wherein either or both the high visibility and reflective colours or materials used in conjunction with the configuration of the indentations and the placement of the indentations on the lifting tine are chosen to comply with a preferred code to enable the operator of the lifting apparatus or people in the vicinity of the lifting apparatus to make a visual appraisal of the inside and outside edges of the tine.

15. Lifting apparatus as claimed in claim 12 wherein the lifting apparatus includes cushioning apparatus operable when an object is being prepared for lifting by the lifting tine.

16. Lifting apparatus as claimed in claim 15 wherein the cushioning apparatus includes at least one telescopic arm.

17. Lifting apparatus as claimed in claim 16 wherein the telescopic arm includes at least two portions.

18. Lifting apparatus as claimed in claim 17 wherein one of the at least two portions of the telescope arm is an outer portion attachable to a portion of the back rest of the lifting apparatus, or adapted to engage with the structure of a machine with which the lifting apparatus is used, but located in the vicinity of the lifting tine.

19. Lifting apparatus as claimed in claim 17 wherein another of the at least two portions of the telescope arm is at least, one inner telescoping portion, extending from the outer portion.

20. Lifting apparatus as claimed in claim 18 wherein the at least two portions of the telescopic arm are operable by any one or more of via connection to the power system of the machine with which the lifting apparatus is used, or via mechanical systems independent of the power system of the machine.

21. Lifting apparatus as claimed in claim 20 wherein the at least two portions of the telescopic arm are operable by hydraulic, pneumatic or resilience means.

22. Lifting apparatus as claimed in claim 21 wherein the resilience operation of the telescopic arm relies on a spring operated system.

23. Lifting apparatus as claimed in claim 22 wherein the cushioning apparatus includes at least two, but preferably three telescopic arms.

24. Lifting apparatus as claimed in claim 23 wherein where three telescopic arms are employed a central telescopic arm is arranged with an outer telescopic arm on each side of the central telescopic arm.

25. Lifting apparatus as claimed in claim 24 wherein where three telescopic arms are employed application of a load to the inner telescopic portion of the central telescopic arm through contact with an object to be lifted effects telescoping of the inner portion of the telescopic arm into the outer portion of that telescopic arm.

26. Lifting apparatus as claimed in claim 25 wherein where three telescopic arms are employed telescoping of the central telescopic arm in turn applies the load to the two outer telescopic arms effecting a complementary telescoping movement therein and displacing the pressure applied to the central telescopic arm.

27. Lifting apparatus as claimed in claim 26 wherein the load is applied via contact of the telescopic arms of the cushioning apparatus with a portion of the object to be lifted by the lifting tine.

28. Lifting apparatus as claimed in claim 27 wherein where the object to be lifted is a pallet, the load is applied via contact of the telescope arms of the cushioning apparatus with the bearers or springers of the pallet in advance of the forklift tines.

29. Lifting apparatus as claimed in claim 28 wherein the cushioning apparatus optionally includes detection means to enable positioning and operation of the cushioning apparatus with reference to the object to be lifted.

30. Lifting apparatus as claimed in claim 29 wherein the detection means are linked to an audible signal producer to alert the operator to the position achieved.

31. Lifting apparatus as claimed in Claim 29 wherein the detection means includes an operating switch.

32. A method of manufacturing lifting apparatus, said lifting apparatus including at least one lifting tine, said lifting tine including an upper surface and a lower surface, said lifting tine also including a heel and a tip, the upper surface being substantially planar, and including the steps of:
a) manufacturing the lower surface to be substantially tapered from the heel of the lifting tine to the tip of the lifting tine, such that the taper of the lower surface includes at least three reductions in the angle of the taper along the length of the tine; and
b) manufacturing a back rest, said backrest being adapted to engage with the structure of a machine with which the lifting apparatus is used.

33. A method of manufacturing lifting apparatus as claimed in claim 32 wherein either or both the lower surface of the lifting tine and the tip of the lifting tine is substantially rounded.

34. A method of manufacturing lifting apparatus as claimed in claim 33 wherein any one or more of the surfaces of the lifting tine and/or the backrest portion of the lifting tine includes indentations.

35. A method of manufacturing lifting apparatus as claimed in claim 34 wherein the indentations include either or both high visibility and reflective colours or materials.

36. A method of manufacturing lifting apparatus as claimed in claim 35 wherein lifting apparatus includes cushioning apparatus operable when an object is being prepared for lifting by the lifting tine.

37. A method of manufacturing cushioning apparatus for use with lifting apparatus as claimed in claim 1 wherein the method includes the steps of:
a) manufacturing at least one telescopic arm, said telescopic arm including at least two portions, an outer portion and at least one inner telescoping portion; and
b) attaching the outer portion to a portion of the back rest of the lifting apparatus, in the vicinity of the lifting tine; and
c) configuring the inner telescoping portion to extend from the outer portion; and
d) adapting the inner telescoping portion to telescope into the outer portion via the operation of mechanical means or via connection to the power system of the machine with which the lifting apparatus is used.

38. A method of manufacturing cushioning apparatus for use with lifting apparatus as claimed in claim 1 wherein the method includes the steps of:
a manufacturing at least one telescopic arm, said telescopic arm including at least two portions, an outer portion and an inner telescoping portion; and
b) adapting the outer portion to engage with the structure of a machine with which the lifting apparatus is used, but located in the vicinity of the lifting tine; and
c) configuring the inner telescoping portion to extend from the outer portion; and
d) adapting the inner telescoping portion to telescope into the cuter portion via the operation of mechanical means or via connection to the power system of the machine with which the lifting apparatus is used.

39. A method of manufacturing cushioning apparatus for use with lifting apparatus as claimed in claim 36 wherein the cushioning apparatus optionally includes detection means.

40. A method of manufacturing cushioning apparatus for use with lifting apparatus as claimed in claim 36 wherein the cushioning apparatus includes switch means.

41. Cushioning apparatus for use with lifting apparatus used to lift an object, said cushioning apparatus including at least one telescopic arm, said cushioning apparatus including at least one telescopic arm including at least two portions, an outer portion and an inner telescoping portion; and the outer portion being adapted to engage with the structure of the lifting apparatus and/or a machine with which the lifting apparatus is used, but located in the vicinity of the lifting tine; and the inner telescoping portion configured to extend from the outer portion; and the inner telescoping portion adapted to telescope into the outer portion via the operation of mechanical means or via connection to the power system of the machine with which the lifting apparatus is used, said cushioning apparatus characterised by the operation of the telescopic arm reducing damage caused to the object by the lifting apparatus.

42. (canceled)

43. (canceled)

44. (canceled)
